(19) United States
(12) Patent Application Publication
(10) Pub. No.: US 2024/0120871 A1
(43) Pub. Date: Apr. 11, 2024

(54) RENEWABLE ENERGY POWERED, PORTABLE AND REMOTE CONTROLLED COMMUNICATION/LIGHTING/MONITORING/SECURITY OR OTHER TYPES OF SYSTEMS REQUIREING POWER AND METHOD

(71) Applicant: JONATHAN RITCHIE, LAS VEGAS, NV (US)

(72) Inventor: JONATHAN RITCHIE, LAS VEGAS, NV (US)

(21) Appl. No.: 17/961,851

(22) Filed: Oct. 7, 2022

(51) Int. Cl. H02S 10/40; B60P 3/00; H02J 7/00; H02J 7/35; H02S 10/20; H02S 30/10; H02S 30/20

(52) U.S. Cl. CPC H02S 10/40; B60P 3/00; H02J 7/0013; H02J 7/35; H02S 10/20; H02S 30/10; H02S 30/20; B62D 63/08; H02J 2300/22

(57) ABSTRACT

A portable, renewable energy powered, and remote controlled unit to provide a municipal infrastructure service has a trailer unit. A base unit is coupled to the trailer unit. A renewable energy power source is coupled to a top surface of the trailer unit. An adjustable service providing unit providing the municipal infrastructure service is coupled to the trailer unit and the renewable energy power source. A control unit is coupled to the base unit and the adjustable service providing unit monitoring operation of the unit and controlling operation of the unit both onsite and remotely.

### TECHNICAL FIELD

The present application generally relates to a portable powered system, and more specifically, to a portable, renewable energy powered, and remote controlled communication/lighting/monitoring/security and like type systems.

### BACKGROUND

There are many instances where portable systems like lighting, communication, monitoring and the like may be needed. For example, during large sporting events, large dirt lots may be used for parking. Most of the time, these dirt lots have no lighting. Portable lighting systems may be used to illuminate these dirt lots for safety and security reasons. Most of these portable lighting systems may be powered by diesel or gasoline generators. These types of generators are noisy, produce pollutants, overheat, and tend to leak and run out of fuel over time.

Further, these types of portable lighting systems have to be manually controlled and/or adjusted onsite. Thus, individuals need to be at the location where the portable lighting system is installed in order to start/stop the portable lighting system, manually adjust a position of a lighting fixture as well as to monitor the operating condition of each unit of the portable lighting system.

Another example of when portable systems may be required is during emergency situations where weather or fire may have destroyed large areas of a municipality. For example, earthquakes, fires, flooding, tornados may damage existing infrastructure within a local area. During these times, portable communication systems, lighting, security, and the like may need to be established. Communication and lighting may need to be established as current systems may have been damaged. Security systems such as video monitoring and the like may need to be established to prevent looting of the damaged area or for other security reasons. Unfortunately, these portable systems suffer from the same issues cited above. Further, during natural disaster like earthquakes, flooding, tornados and the like, it may be difficult to find fuel for powering the generators for these portable systems.

Therefore, it would be desirable to provide a device and method that overcomes the above. The device and method would provide a portable, renewable energy powered, and remote controlled communication/lighting/monitoring/security.

### SUMMARY

In accordance with one embodiment, a portable, renewable energy powered, and remote controlled unit to provide a municipal infrastructure service is disclosed. The portable, renewable energy powered, and remote controlled unit to provide a municipal infrastructure service has a trailer unit. A base unit is coupled to the trailer unit. A renewable energy power source is coupled to a top surface of the trailer unit. An adjustable service providing unit providing the municipal infrastructure service is coupled to the trailer unit and the renewable energy power source. A control unit is coupled to the base unit and the adjustable service providing unit monitoring operation of the unit and controlling operation of the unit both onsite and remotely.

In accordance with one embodiment, a portable, renewable energy powered, and remote controlled unit to provide a municipal infrastructure service is disclosed. The portable, renewable energy powered, and remote controlled unit to provide a municipal infrastructure service has a trailer unit. A trailer hitch is hingly coupled to the trailer unit, the trailer hitch folding upward for storage when the unit is not in use and folded downward when towing the unit. A base unit is coupled to the trailer unit. A renewable energy power source is coupled to a top surface of the trailer unit. The renewable energy power source has a frame coupled to the top surface of the trailer unit, wherein the frame is a sliding frame having a main frame unit coupled to the top surface of the trailer unit and a plurality of side frames, wherein at least one side frame is positioned on opposing sides of the main frame, wherein each side frame slides under the main frame. At least one solar panel is coupled to the main frame and each side frame. An adjustable service providing unit providing the municipal infrastructure service is coupled to the trailer unit and the renewable energy power source. A control unit is coupled to the base unit and the adjustable service providing unit monitoring operation of the unit and controlling operation of the unit both onsite and remotely, wherein the control unit controls operation of individual components of the adjustable service providing unit by tilting, rotating and tracking operating parameters of the individual component.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a perspective view of an exemplary embodiment of a portable, renewable energy powered, and remote controlled communication/lighting/monitoring/security and like types of systems, in accordance with an aspect of the present invention;

FIG. 2 is a perspective view of an exemplary embodiment of a single unit of the system of FIG. 1, in accordance with an aspect of the present invention;

FIG. 3 is a perspective view of an exemplary embodiment of the single unit of the system of FIG. 1 with the solar panels and service providing unit extended for use, in accordance with an aspect of the present invention;

FIG. 4 is a rear perspective view of an exemplary embodiment of the single unit of the system of FIG. 1 with the solar panels extended, in accordance with an aspect of the present invention;

FIG. 5 is a perspective view of an exemplary embodiment of a trailer hitch used on the single unit of the system of FIG. 1, in accordance with an aspect of the present invention;

FIG. 6 is a cut away perspective view of an exemplary embodiment of an interior of the single unit of the system of FIG. 1, in accordance with an aspect of the present invention;

FIG. 7 is a magnified perspective view of an exemplary embodiment of a service providing unit used on the single unit of the system of FIG. 1, in accordance with an aspect of the present invention; and

FIG. 8 is a block diagram of an exemplary embodiment of a control unit of the single unit of the system of FIG. 1, in accordance with an aspect of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary portable, renewable energy powered system is disclosed. The system may allow for users to establish communication/lighting/monitoring/security systems in any location. The system may be powered by a renewable energy source thereby eliminating the issues with having a fossil fuel generator power each individual units of the system. Each unit of the system may be remotely controlled to adjust a configuration of each unit.

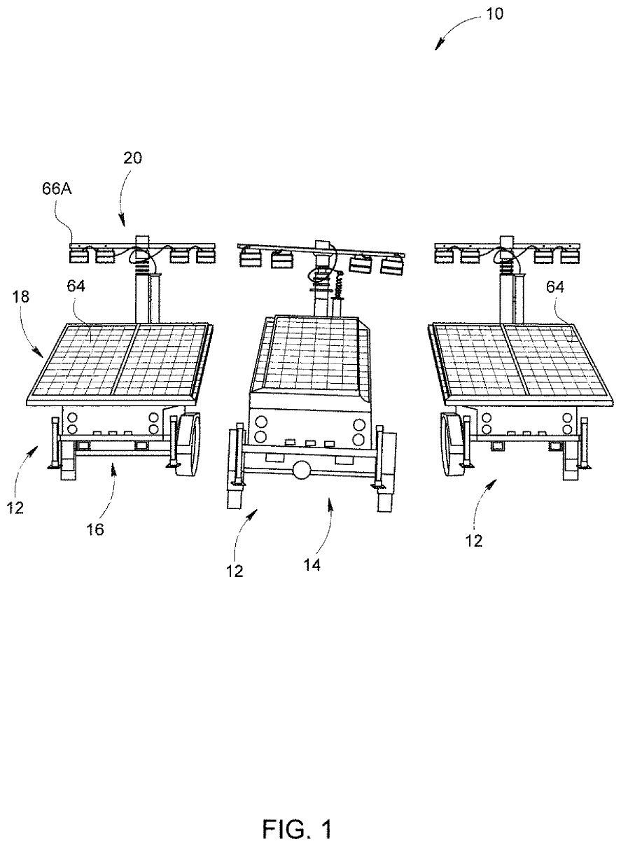

Referring to FIG. 1, a portable, renewable energy powered, and remote controlled communication/lighting/monitoring/security or similar type of systems that may require continuous running power supplies 10 (hereinafter system 10) may be seen. The system 10 may be used to establish communication/lighting/monitoring/security or similar types of services in any location. The system 10 may be powered by a renewable energy source thereby eliminating the issues with having a fossil fuel generator powering each individual unit 12 of the system 10. Each unit 12 of the system 10 may be remotely controlled to adjust a configuration of each unit 12.

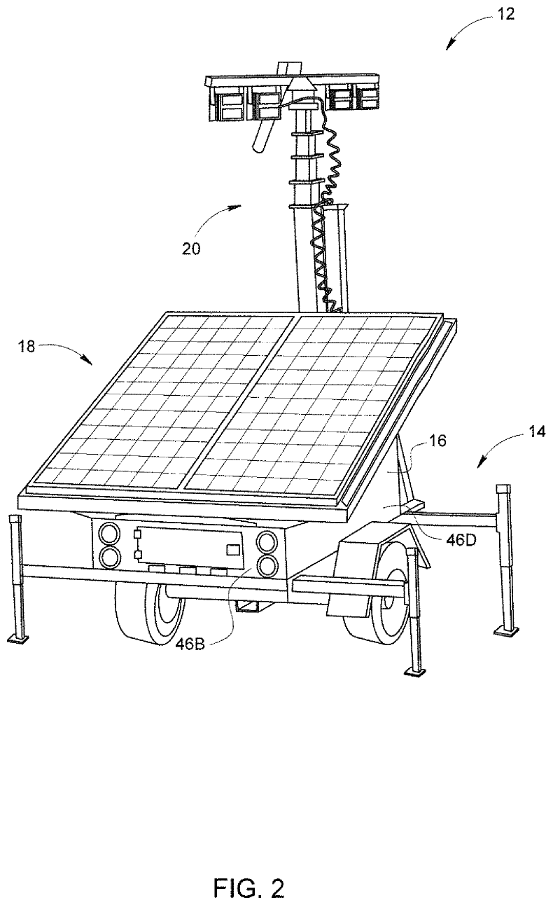

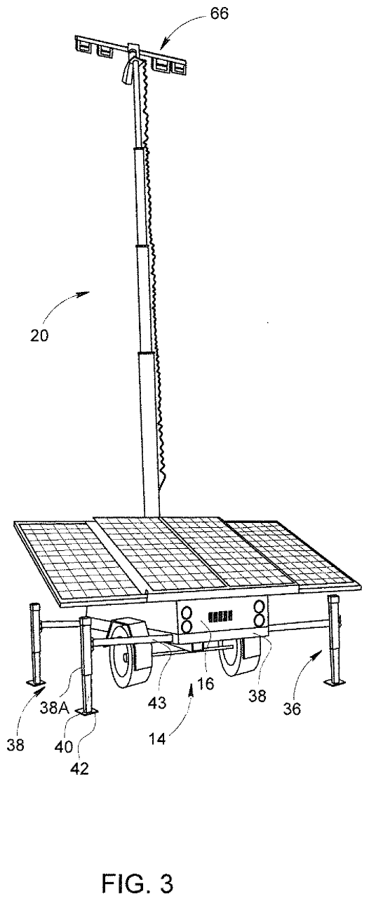

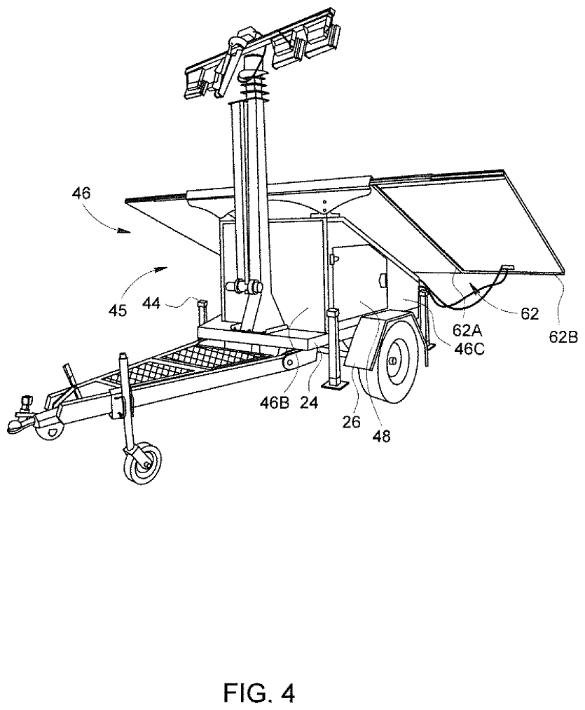

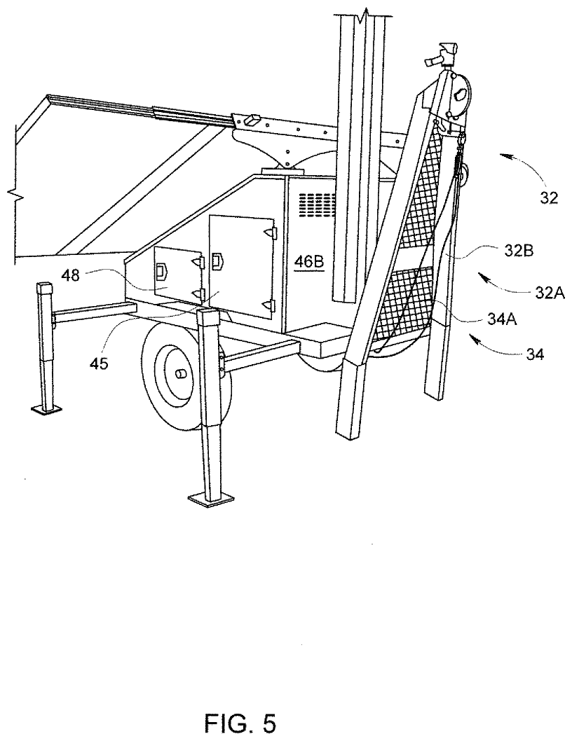

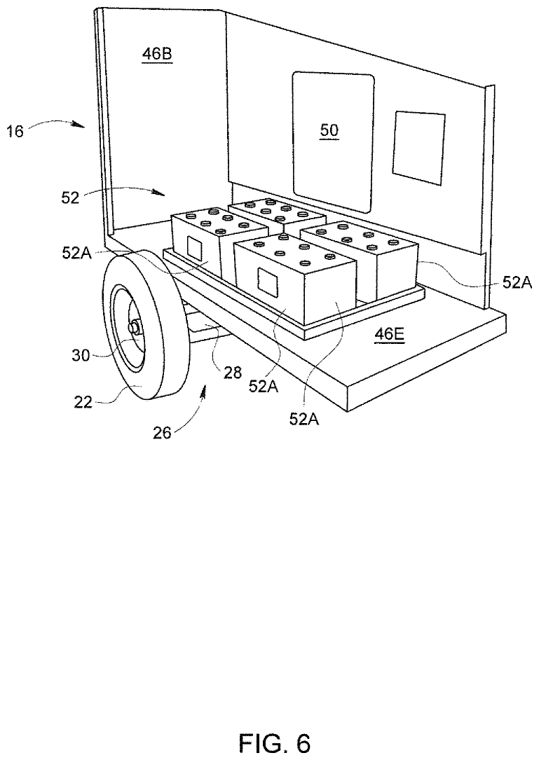

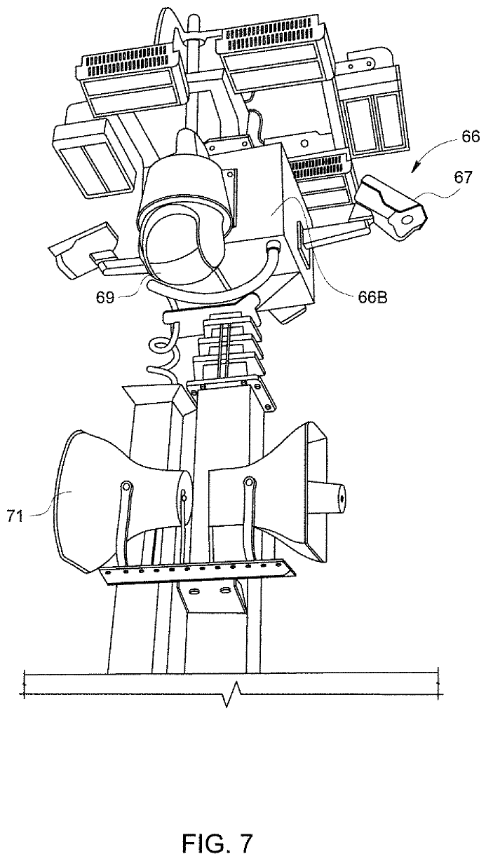

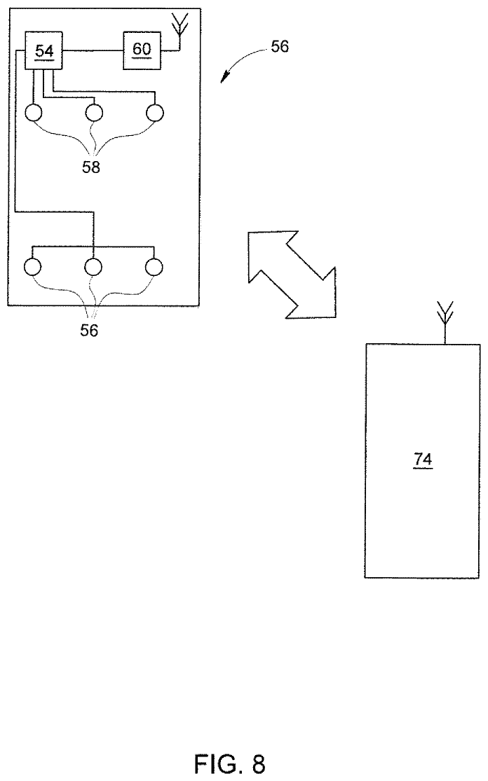

Referring to FIGS. 1-8, a unit 12 of the system 10 may be disclosed. Each unit 12 of the system 10 may be formed of a trailer unit 14, a housing 16, a renewable energy power source 18, and an adjustable service providing unit 20. The adjustable service providing unit 20 may be used to provide lighting, communication, security, and other services as may be described below.

Each unit 12 may have a trailer unit 14. The trailer unit 14 may be used to transport a corresponding unit 12. The trailer unit 14 may be formed of a trailer frame 24. The trailer frame 24 may be constructed out of any material to provide sufficient strength and durability, such as steel, other metals and alloys, composites, and the like. An axle assembly 26 may be coupled to the trailer frame 24. The axle assembly 26 may have an axle shaft 28 coupled to the trailer frame 24. A drum assembly 30 may be coupled to each end of the axle shaft 28. A wheel 22 may be coupled to each drum assembly 30 on each end of the axle shaft 28.

A trailer hitch 32 may be hingly coupled to the trailer frame 24. The trailer hitch 32 may be formed of the same and/or similar materials as the trailer frame 24. The trailer hitch 32 may be moveable such that the trailer hitch 32 may be folded upward when the trailer hitch 32 is not needed in order to lessen the footprint of the unit 12 and folded downward when the unit 12 may need to be moved. The trailer hitch 32 may be formed of an “A” frame structure 32A. Each leg 32B of the “A” frame structure 32A may be hingly coupled to an opposing side of the trailer frame 24. A bottom section of each leg 32B may extend into a corresponding “U” channeling 24A of the trailer frame 24 when the trailer hitch 32 is folded downward. This may allow for the trailer unit 14 to be more stable when transporting the unit 12.

A top front surface of the “A” frame structure 32A may have a floor 34 coupled thereto. The floor 34 may allow a user to stand on top of the “A” frame structure 32A. In accordance with one embodiment, the floor 34 may be a floor grating 34A. The floor grating 34A may provide traction and allow water and other elements to drain off thereby providing a safer area for a user to stand on the “A” frame structure 32A.

Support feet 36 may be coupled to the trailer frame 24. The support feet 36 may provide additional support/stability for the unit 12 on any type of terrain. The support feet 36 may be adjustable. The support feet 36 may move in a vertical and/or horizontal direction relative to the trailer frame 24. Thus, the support feet 36 may extend down from the trailer frame 24 as well as away from the trailer frame 24 in order to engage a ground area where the unit 12 may be positioned. The adjustable nature of the support feet 36 may provide a solid, stable base by distributing the weight of the unit 12 over a wider area.

In accordance with one embodiment, each of the support feet 36 may have a housing 38. The housing 38 may be hollow tubing 38A or the like. A first retractable leg 40 may be positioned within the housing 38. A support foot 42 may be attached to a first end of the first retractable leg 40 and extends out from the housing 38. A second end of the first retractable leg 40 may be coupled to an extending/retracting device 44. The extending/retracting device 44 may be used to extend and retract the first retractable leg 40 as well as to lock the first retractable leg 40 in a vertical position relative to the trailer frame 24. The extending/retracting device 44 may be a manual device such as a crank arm or the like for extending, retracting and locking the retractable leg 40. Alternatively, the extending/retracting device 44 may be an automated device such as an electronic, pneumatic, or similar type of motor device for extending, retracting and locking the retractable leg 40.

A second retractable leg 43 may be coupled to the housing 38. The second retractable leg 43 may be used to extend the housing 38 horizontally away from the trailer frame 24. The second retractable leg 43 may have a first end coupled to the housing 38. A second end of the second retractable leg 43 may be slidably coupled to the trail frame 24. This may allow the second retractable leg 43 to extend the housing 38 horizontally in and out of the trailer frame 24. The second retractable leg 43 may be extended/retracted manually or alternatively, the second retractable leg 43 may be coupled to the extending/retracting device 44 to extend, retract and lock the second retractable leg 43.

Located on top of the trailer frame 24 is a base unit 45. The base unit 45 may have a housing 46. The housing 46 may have a front wall 46A, rear wall 46B and two opposing side walls 46C and 46D. In accordance with one embodiment, the rear wall 46B may be higher than the front wall 46A so that the base unit 44 may angle downward from the rear wall 46B to the front wall 46A. The base unit 44 may further have a floor 46E and a top 46F.

One or more doors 48 may be formed in the base unit 45. The doors 48 may allow one to access the interior of the base unit 45. Alternatively, or in addition to, one or more doors 48 may house and allow access to a control unit 50. The control unit 50 may allow a user to control operations of the unit 12 locally as may be described below.

The base unit 45 may be used to house a battery pack 52. The battery pack 52 may be positioned on the floor 46E of the base unit 45. While the present embodiment may show the battery pack 52 having four batteries 52A, this is shown as an example and should not be seen in a limiting manner. The battery pack 52 may have any number of batteries 52A. The battery pack 52 may be used for powering the unit 12 and/or one or more components of the unit 12 as will be described below.

In accordance with one embodiment, the battery pack 52 may be rechargeable. Individual batteries 52A and/or the battery pack 52 may be charged/recharged via the renewable energy power source 18 as may be described below.

The control unit 50 may be housed within the base unit 45. In accordance with one embodiment, the control unit 50 may be housed within the base unit 45 and behind one of the doors 48. The control unit 50 may be formed of a microprocessor 54. The microprocessor 54 may be programmed to control operations of the unit 12. The control unit 50 may have a plurality of switches 56 coupled to the microprocessor 54. The switches 56 may be used for controlling operation of the unit 12. For example, one or more switches 56 may be used to control the adjustable service providing unit 20. The switches 56 may allow the user positioned near the unit 12 to raise and lower the adjustable service providing unit 20. The switches 56 may allow the user to adjust not only a height of the adjustable service providing unit 20 but to adjust other positions such as, but not limited to tilting, rotating or other adjustments to the position of the adjustable service providing unit 20.

The control unit 50 may have a one or more gauges 58 coupled to the microprocessor 54. The gauges 58 may be used for monitoring the operating conditions of the unit 12. For example, the gauges 58 may be used to show a power capacity of the battery pack 52, charging level of the battery pack 52, or other operating features of the unit 12.

The control unit 50 may have a transmitter/receiver 60 coupled to the microprocessor 54. The transmitter/receiver 60 may be used to wirelessly transmit data to and from the control unit 50. By allowing the transmission of data to and from the control unit 50, one may access and remotely control/monitor operations of the unit 12. The receiver/transmitter 60 may be designed to work on any wireless network/standard. In accordance with one embodiment, the receiver/transmitter 60 may be designed to function on a cellular network. However, this is given as an example and should not be seen in a limiting scope.

Individuals may use one or more computing devices 74 to access the control unit 50 via the transmitter/receiver 60. The computing devices 74 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like. The computing device 74 may be described in the general context of computer system executable instructions, such as program modules, being executed by a computer system as may be described below.

The computing device 74 may be loaded with an operating system. The operating system of the computing device 74 may manage hardware and software resources of the computing device 74 and provide common services for computer programs running on the computing device 74. The computing device 74 may gain online access to a network 76 such as the World Wide Web. By connecting to the network 76, the computing device 74 may access the control unit 50 via the transmitter/receiver 60 in order to control/monitor the unit 12.

Located on the top 46F of the base unit 45 may be the renewable energy power source 18. The renewable energy power source 18 may be used to power the unit 12 and/or to recharge the battery packs 52. In the present embodiment, the renewable energy power source 18 is a solar energy power source. The solar energy power source may be formed of a frame 62. The frame 62 may be attached to the top 46F of the base unit 45. The frame 62 may be used to house one or more solar panels 64. In accordance with one embodiment, the frame 62 may have a main frame unit 62A. The main frame unit 62A may be attached to the top 46F of the base unit 45. One or more side frame units 62B may be slidably connected to the main frame unit 62A. The side frame units 62B may be slidably connected to the main frame unit 62A such that each side frame units 62B may slide under the main frame unit 62A for storage. If there are multiple side frame units 62B on one side of the main frame unit 62A, each side frame unit 62B may slide under a directly adjacent side frame unit 62B such that all side frame units 62B on one side of the main frame unit 62A will slide under the main frame unit 62A. Thus, having multiple side frame units 62B slide within one another allows the unit 12 to have multiple solar panels 64 for powering the unit 12.

The unit 12 may have an adjustable service providing unit 20. The adjustable service providing unit 20 may be used to provide portable communication/lighting/monitoring/security and/or other services to a desired area. The adjustable service providing unit 20 may have a service module 66. The service module 66 may be used to provide a desired service of the unit 12. For example, the service module 66 may be a communication module. The communication module may be a antenna structure capable of delivering Wifi, 4G, LTE, CDMA, 5G, PTP, PTMP, CBRS, or any custom or proprietary communications band or frequency signals. The service module 66 may be a lighting module 66A to provide direct and indirect lighting to areas that may require light sources. The lighting module 66A may have individual lighting elements 66A′ which can be controlled/adjusted by the control panel 50 as described above and further below.

The service module 66 may be a surveillance module 66B to provide monitoring of areas for security or other reasons. The surveillance module may have surveillance cameras 67, thermography for viral and health detection, security disturbance detection 69, weapons detection, listening devices, audible warning devices 71 and the like. The surveillance module may be weather detection devices such as environmental and atmospheric sensors, air pollution sensors, rain sensors, and the like. The above are given as examples and should not be seen in a limiting manner.

The service module 66 may have adjustment mechanisms 66A positioned therein. The adjustment mechanisms 66A may be coupled to the control unit 50. The adjustment mechanisms 66A may be used to control/adjust operation of the service module 66. Thus, all the sensors, antennas, or other technology required to achieve the aforementioned functions can be moved, controlled. The service module 66 may be controlled/adjusted on-site manually, mechanically, or electronically or remotely. Using the computing device 74 as described above, one may access the control unit 50 in order to remotely control the unit 12. The user may monitor the operating conditions of the unit 12 and adjust the service module 66 to optimize the performance of the unit 12. For example, if the service module 66 is a communication module, the user may monitor the operating frequency of the signals and then rotate and tilt the service module 50 in order to line up to the perfect strength for any technology stack available. In accordance with one embodiment, the unit 12 may provide auto tracking and autonomous maintenance to provide optimal signal strength.

For example, if the service module 66 is a lighting service module, the adjustment mechanisms 66A may be used to tilt, rotate or perform other adjustments to individual lighting elements of the lighting service module. If the service module is a video surveillance service module, the adjustment mechanisms 66A may be used to tilt, rotate, adjust a focus, zoom, or perform other adjustments to individual video cameras of the video surveillance service module. The above are given as examples and should not be seen in a limiting manner. The adjustment mechanisms 66A may be used to perform other functions than those listed above.

The adjustable service providing unit 20 may have a telescoping assembly 68. The telescoping assembly 68 may be used to raise and lower the service module 66. The telescoping assembly 68 may be formed of a telescopic pole 70. A proximate end of the telescopic pole 70 may be coupled to the trailer frame 24. The service module 66 may be coupled to a distal end of the telescopic pole 70. A lift mechanism 72 may be used to raise, lower and lock the telescopic pole 70 in a desired position. The lift mechanism 72 may be manual or automated device. In accordance with one embodiment, the lift mechanism 72 may be a hydraulic lift, a motor, or similar type of device. If the lift mechanism 72 is an automated device, the lift mechanism 72 may be coupled to the battery pack 52 and the control unit 50 in order to raise, lower and lock the telescopic pole 70.

The foregoing description is illustrative of particular embodiments of the application but is not meant to be a limitation upon the practice thereof. For example, while the cover 10 may be described as being formed of multiple pieces, the cover 10 may be formed of a single piece with the hinged lid 42. The following claims, including all equivalents thereof, are intended to define the scope of the application.

What is claimed is:

1. A portable, renewable energy powered, and remote controlled unit to provide a municipal infrastructure service comprising:
a trailer unit;
a base unit coupled to the trailer unit;
a renewable energy power source coupled to a top surface of the trailer unit;
an adjustable service providing unit providing the municipal infrastructure service coupled to the trailer unit and the renewable energy power source; and
a control unit coupled to the base unit and the adjustable service providing unit monitoring operation of the unit and controlling operation of the unit both onsite and remotely.

2. The unit of claim 1, wherein the control unit controls operation of individual components of the adjustable service providing unit by tilting, rotating and tracking operating parameters of the individual component.

3. The unit of claim 1, wherein the renewable energy power source is a solar power source.

4. The unit of claim 1, wherein the renewable energy power source comprises:
a frame coupled to the top surface of the trailer unit, wherein the frame is a sliding frame comprising:
a main frame unit coupled to the top surface of the trailer unit; and
a plurality of side frames, wherein at least one side frame is positioned on opposing sides of the main frame, wherein each side frame slides under the main frame; and
at least one solar panel coupled to the main frame and each side frame.

5. The unit of claim 4, wherein the renewable energy power source comprises a battery pack stored in the base unit and coupled to the solar panels.

6. The unit of claim 1, comprising a trailer hitch hingly coupled to the trailer unit, the trailer hitch folding upward for storage when the unit is not in use and folded downward when towing the unit.

7. The unit of claim 6, wherein the trailer hitch comprises an “A” shape frame, wherein a bottom area of each leg of the “A” shaped frame extends into a corresponding channel of the trailer unit when the trailer hitch is folded downward.

8. The unit of claim 7, wherein the trailer hitch comprises a grating attached to a top surface of the “A” shaped frame.

9. The unit of claim 1, wherein the adjustable service providing unit comprises:
a service unit providing a desired municipal infrastructure service;
a telescopic assembly raising, lowering and locking the service unit in a vertical direction relative to the trailer frame;
an adjustment mechanism coupled to the service unit tilting, rotating, and tracking operating parameters of individual components of the service unit.

10. The unit of claim 9, wherein the telescopic assembly comprises:
a telescopic pole having a proximate end coupled to the trailer frame and a distal end coupled to the service unit; and
a lifting mechanism coupled to the telescopic pole and the control unit.

11. The unit of claim 1, wherein the adjustable service providing unit is a lighting unit, the control unit allowing onsite and remote access to control the tilting and rotating of individual lighting elements of the lighting unit.

12. The unit of claim 1, wherein the adjustable service providing unit is a communication unit, wherein the communication unit is configurable of delivering Wifi, 4G, LTE, CDMA, 5G, PTP, PTMP, CBRS, or any custom or proprietary communications band or frequency signal.

13. The unit of claim 1, comprising a plurality of support feet coupled to the trailer unit.

14. The unit of claim 13, wherein each of the support feet is adjustable horizontally and vertically relative to the.

15. A portable, renewable energy powered, and remote controlled unit to provide a municipal infrastructure service comprising:
a trailer unit;
a trailer hitch hingly coupled to the trailer unit, the trailer hitch folding upward for storage when the unit is not in use and folded downward when towing the unit;
a base unit coupled to the trailer unit;
a renewable energy power source coupled to a top surface of the trailer unit, wherein the renewable energy power source comprises:
a frame coupled to the top surface of the trailer unit, wherein the frame is a sliding frame comprising:
a main frame unit coupled to the top surface of the trailer unit; and
a plurality of side frames, wherein at least one side frame is positioned on opposing sides of the main frame, wherein each side frame slides under the main frame; and
at least one solar panel coupled to the main frame and each side frame;
an adjustable service providing unit providing the municipal infrastructure service coupled to the trailer unit and the renewable energy power source; and
a control unit coupled to the base unit and the adjustable service providing unit monitoring operation of the unit and controlling operation of the unit both onsite and remotely, wherein the control unit controls operation of individual components of the adjustable service providing unit by tilting, rotating and tracking operating parameters of the individual component.

16. The unit of claim 15, wherein the renewable energy power source comprises a battery pack stored in the base unit and coupled to the solar panels.

17. The unit of claim 15, wherein the trailer hitch comprises:
an “A” shape frame, wherein a bottom area of each leg of the “A” shaped frame extends into a corresponding channel of the trailer unit when the trailer hitch is folded downward; and
a grating attached to a top surface of the “A” shaped frame.

18. The unit of claim 15, wherein the adjustable service providing unit comprises:
a service unit providing a desired municipal infrastructure service;
a telescopic assembly raising, lowering and locking the service unit in a vertical direction relative to the trailer frame, wherein the telescopic assembly comprises:
a telescopic pole having a proximate end coupled to the trailer frame and a distal end coupled to the service unit; and
a lifting mechanism coupled to the telescopic pole and the control unit; and
an adjustment mechanism coupled to the service unit tilting, rotating, and tracking operating parameters of individual components of the service unit.

19. The unit of claim 15, wherein the adjustable service providing unit is a lighting unit, the control unit allowing onsite and remote access to control the tilting and rotating of individual lighting elements of the lighting unit.

20. The unit of claim 15, wherein the adjustable service providing unit is a communication unit, wherein the communication unit is configurable of delivering Wifi, 4G, LTE, CDMA, 5G, PTP, PTMP, CBRS, or any custom or proprietary communications band or frequency signal.

21. The unit of claim 15, comprising a plurality of support feet coupled to the trailer unit, wherein each of the support feet is adjustable horizontally and vertically relative to the trailer unit.
